(19) United States
(12) Patent Application Publication
(10) Pub. No.: US 2005/0025326 A1
(43) Pub. Date: Feb. 3, 2005

(54) Modular speaker system for a portable electronic device

(76) Inventors: Saied Hussaini, Miami, FL (US); Marc Iacovelli, Miami, FL (US)

Correspondence Address: LINIAK, BERENATO & WHITE, Suite 240, 6550 Rock Spring Drive, Bethesda, MD, 20817, US

(21) Appl. No.: 10/631,016

(22) Filed: Jul. 31, 2003

(51) Int. Cl. H04R 1/02; H04R 9/06

(52) U.S. Cl. 381/333; 381/388; 381/87

(57) ABSTRACT

A modular attachable/detachable speaker system is designed to plug-in to portable electronic equipment, such as a GAME BOY ADVANCE SP®. The invention comprises a base unit and two speakers rotatably attached to a backing panel. The base unit includes at least one plug located on a first side to electronically commnunicate with the host portable electronic device. The base unit also includes a pass through devices on a second side to allow electronic signals and power to pass through the base unit to an auxiliary device, another gaming device or other accessories. Sound-generating signals are channeled from the host portable electronic device, through the base unit, to the backing panel, and further to the two speakers. The speakers provide enhanced stereo sound for the host portable electronic device.

### BACKGROUND OF THE INVENTION

1. Field of the Invention

The invention generally relates to audio accessories for electronic equipment. Specifically, the invention relates to a sound-enhancing accessory for a portable electronic amusement device.

2. Description of the Background Art

Portable electronic equipment with audio capability typically includes a speaker component built directly into the portable electronic device itself. While this arrangement is convenient, it limits both the quality and quantity of sound that may be generated. Other audio systems that deliver additional sound require a cord/speaker-wire type attachment to the body of the host equipment. While this arrangement delivers a higher quantity and quality of sound, the configuration is cumbersome, requires multiple independent components, and is not conveniently transportable. Additionally, an auxiliary power source may be required to run the sound system. Although the speakers are of a higher quality, this quality is often not fully utilized because of the limitations of the sound generating capabilities of typical hand-held electronic equipment.

To address these issues, the present invention has been developed. The invention plugs directly into the body of a host electronic device, allowing it to be transported as if it were an original part of the device. The invention also includes pass-through ports that enable the attachment of an identical or similar electrical device, or associated accessories, while at the same time significantly enhancing the quality of sound available.

### SUMMARY OF THE INVENTION

The invention comprises an attachable/detachable modular, speaker system for use with a portable electronic device. Specifically, the modular speaker system is designed for use with a GAME BOY ADVANCE SP® (GBASP). The invention comprises a base unit and two speakers rotatably attached to a backing panel. The base unit includes at least one plug located on a first side to electronically communicate with the host portable electronic device. The base unit also includes plugs on a second side to allow electronic signals and power to pass through the base unit to an identical or similar electrical device, other accessories.

Sound-generating signals are channeled from the host portable electronic device, through the base unit, to the backing panel, and further to the two speakers. The speakers provide enhanced stereo sound for the host portable electronic device.

### BRIEF DESCRIPTION OF THE DRAWINGS

FIG. 1 discloses an isometric view of the invention installed in a host portable electronic device (a GBASP). In this view, the speakers are in their extreme lateral position.

FIG. 2 discloses a side view of the invention in the installed position, as shown in FIG. 1.

FIG. 3 discloses a top view of the invention in the installed position with the GBASP removed from the invention. The speakers remain in the extreme lateral position.

FIG. 4 discloses a top view of the invention as disclosed in FIG. 3, however, the speakers have been rotated upward (note the arrows) to their extreme vertical position.

FIG. 5 discloses a side view with the GBASP attached and the speakers in their extreme vertical position. The arrows show the direction of rotation to move the backing panel and speakers to the stored position.

FIG. 6 discloses a side view of the GBASP attached, and the invention in the stored position.

FIG. 7 discloses a rear view of the invention as shown in FIG. 6. The invention is in the stored position with the GBASP attached.

### DETAILED DESCRIPTION OF THE INVENTION

An embodiment of the present invention will now be described with reference to the accompanying drawings. It should be noted that the terms “up,” “down,” upright,” and “lateral” are used with reference to the invention in the installed position.

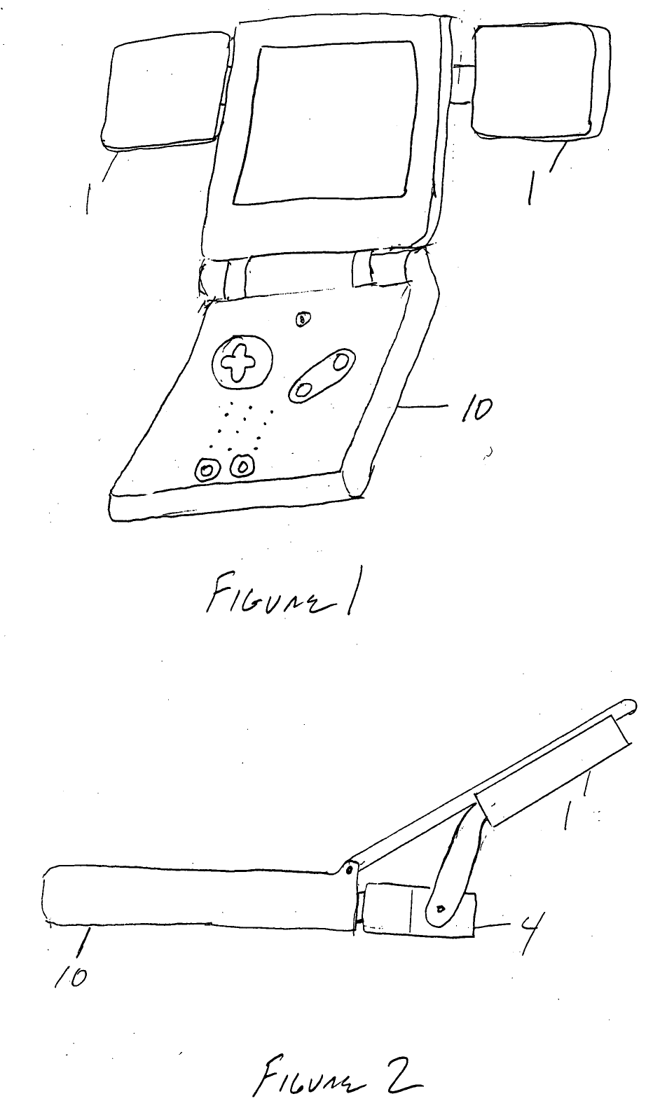

The invention has two locked positions—an installed position as shown in FIGS. 1-5, and a stored position, as shown in FIG. 6-7. The locking mechanism is comprised of a spring-biased rotatable pivot, with detents in the locking positions. The lock can be easily overcome by firmly applying force and rotating the invention out of the locked position.

In FIG. 1, the invention is in the installed position, and is connected to the GBASP (10). Speakers (1) extend laterally from behind the GBASP (10) to provide an improved quality and quantity of sound. FIG. 2 shows a side view of the invention as shown in FIG. 1. FIG. 2 shows the GBASP connected to the invention base unit (4).

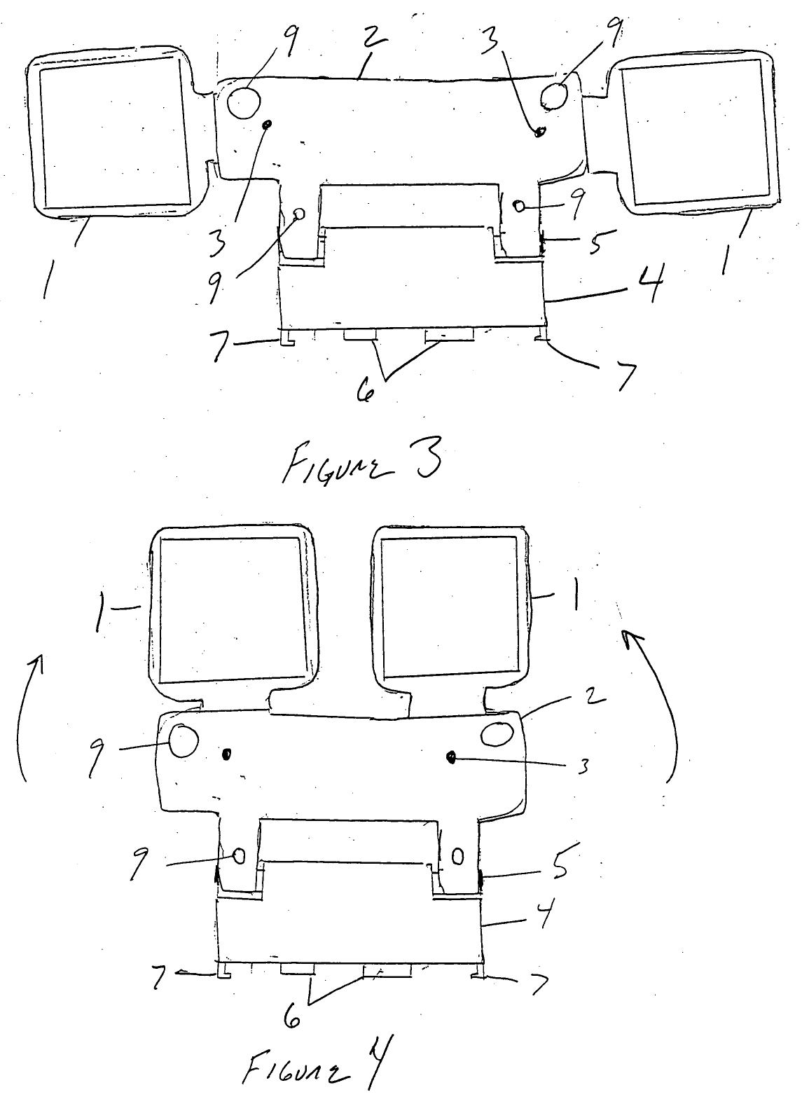

FIG. 3 is a top view of the invention in the installed position with the GBASP (10) removed. Two speakers (1) are rotatably mounted to a backing panel (2). The speakers (1) rotate about a speaker pivot point (3) from an extreme lateral position, as shown in FIGS. 1-3, to an extreme vertical position, as shown in FIGS. 4-7. The arrows in FIG. 4 generally describe the speakers' plane of rotation.

A backing panel (2) is rotatably connected to the base unit (4). The backing panel includes cloth pads (9) to cushion the back of the GBASP (10). The backing panel (2) rotates relative to the base unit (4) about a base unit pivot point (5). The base unit (4) plane of rotation is perpendicular to the speakers' (1) rotation plane. Locking tabs (7) on the sides of the base unit (4) help to ensure that the invention stays connected to the GBASP.

The base unit (4) communicates electrically with the GBASP via the communication ports/plug in devices (6). Communication ports (6) on the front of the base unit (4) relay power, and audio/video signals from the GBASP (10) to the base unit (4). Information is also relayed to electronic pass-through ports (8), visible in FIG. 7. The pass-through ports (8) are located on the rear of the base unit (4), and mirror the communication ports on the gaming device to which the communication ports/plug-ins devices (6) attach. Thus if separated, the plug in devices (6) could connect to corresponding pass through ports (8). The pass-through ports (8) can communicate power and audio/video information to other auxiliary equipment, or to another GBASP. The specific wiring configuration required in order to configure the aforementioned operations are well within the skill of one of ordinary skill in the art and need no further elaboration. The plug in (6) and pass through (8) devices include a first plug in to communicate with the audio/command signal output of the GBASP. This allows the speaker system to tap into the audio signals to activate the speakers and enhance the sound of the game device. As previously indicated, the base unit includes a corresponding pass through device (8) to permit additional connection to an external device and pass through the very same audio/command signals produced by the game unit. The base unit also includes a second plug in (6), and pass through (8) device to facilitate a pass through of the second output of the GBASP through the modular speaker system. The two plug ins (6) and pass through (8) devices allow the base unit of the modular speaker system to connect to the Game device, such as GBASP, tap into the audio/signal for powering the speakers, and establish a pass through communication through to an external device. Therefore, when utilizing the modular speaker system of the present invention, the ports on the GBASP remain operational for possible communication with external devices, such as a charging device to charge the internal batter pack of the GBASP, communicate with another GBASP device and otherwise permitting all functional communication and connections as if directly connected to the rear of the GBASP device. Thus the pass through (8) devices mirrors that of the communication ports of the GBASP device. As the GBASP device is well known in the art, the specific configuration of the internal wiring etc. is straight forward and within the knowledge of one of ordinary skill in the art.

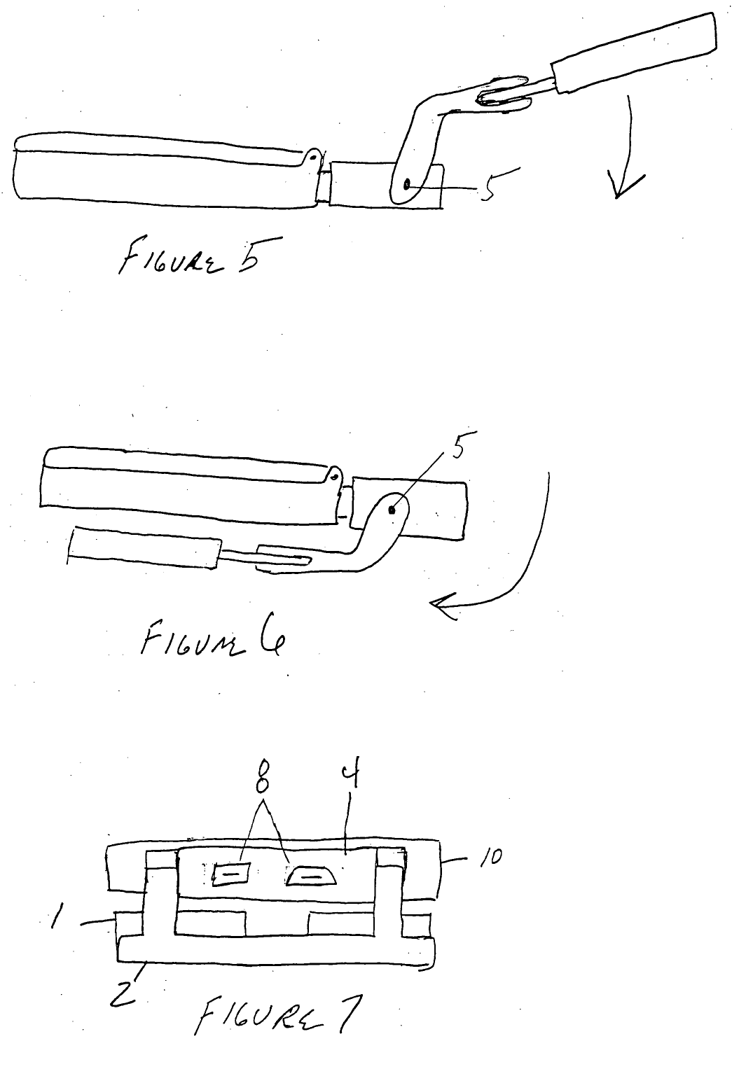

The speaker system according to the present invention may be moved to a stored position while connected to the game device. To move the invention into the stored position, the speakers are generally rotated to the extreme vertical position, as shown in FIG. 4, although the invention can be stored with the speakers in the extreme lateral position. The arrows in FIGS. 5 and 6 illustrates the direction of rotation required to move the invention from the installed position, as shown in FIG. 5, to the stored position, as shown in FIGS. 6 and 7. The backing panel and speakers may also be rotated about the base unit pivot point (5) in excess of one hundred eighty degrees and thus fold down adjacent to the Game device in a more compact fashion.

FIG. 7 shows a rear view of the invention as shown in FIGS. 5 and 6. As indicated in FIGS. 6 and 7, in the stored position, the backing panel (2) is parallel to the base unit (4), and the base of the GBASP is positioned above the backing panel and speakers. In the stored position, the invention has a significantly narrower vertical profile that in its installed position. The pass-through ports (8) are also clearly visible in FIG. 7.

In operation, the invention is rotated to the installed position, and plugged into a GBASP. Power and audio/video signals are communicated from the GBASP (10) to the base unit (4) through the communication ports (6). The base unit (4) routes sound information to the backing panel (2) and on to the speakers (1). The base unit (4) also routes power such as input power to charge GBASP battery pack and audio command signals to the pass-through ports (8) for use with auxiliary equipment or another GBASP (10). When the user is ready to end the session and store the device, the base unit (4) is rotated in excess one hundred eighty degrees and locked in the stored position. The speaker system may remain connected to the BP SP when in the stored position.

For the foregoing reasons, it is clear that the invention provides an improved sound generating capability for a GBASP. The modular, compact, device is specifically designed to enhance the sound of hand-held video game devices or other portable electrical equipment, while maintaining at least one “pass-through” accessory port (8) for additional applications. The device allows the user to rotate the speakers to various positions to optimize the sound quality, and tailor it to a specific application, while maintaining a rigid connection between the host electrical device and the speakers. When the user is finished, the invention folds to a minimal profile for storage and transport.

Although the invention is specifically designed for a GBASP, it may have additional application to multiple other portable and stationary electronic devices. The invention may be used in any application in which supplementary audio capability is needed or desired. Similarly, although the materials of construction are not described, they may include a variety of compositions consistent with the function of the invention, such as metal, plastic, fiberglass, epoxy composites, wood, etc. Such variations are not to be regarded as a departure from the spirit and scope of the invention, and all such modifications as would be obvious to one skilled in the art are intended to be included within the scope of the following claims.

1. An audio accessory system for use with a portable electronic device, said system comprising:
two speakers,
said speakers being individually rotatably mounted to a single common backing panel, and,
a base unit being rotatably mounted to said backing panel,
said base unit having at least one plug-in device to communicate with said portable electronic device.

2. The system as described in claim 1, wherein said base unit includes at least two 1 plug-in devices.

3. The system as described in claim 2, wherein said base unit has at least one pass-through port to facilitate communication between the portable electronic device and an auxiliary accessory while said audio accessory is connected to said portable electronic device.

4. The system described in claim 2, wherein said base unit has at least two pass-through ports.

5. The system as described in claim 4, wherein said speakers have an extreme vertical position that is perpendicular to said backing panel, and an extreme lateral position that is axially aligned with said backing panel,
said speakers being movable to any position between said extreme vertical and extreme lateral positions.

6. The system as described in claim 5, wherein said system has two locking positions.

7. The system as described in claim 6, wherein said locking positions include an installed position and a stored position, said installed position comprising the position in which said system is installed in said portable electronic device, and said stored position wherein said system in said stored position has a narrower profile than said system in said installed position.

8. The system as described in claim 7, wherein said system is changed from said installed position to said stored position by rotating said speakers and said backing panel in excess of one hundred eighty degrees.

9. The system described in claim 7, wherein said backing panel is parallel with said base unit when said system is in said stored position.

10. The system described in claim 7, wherein said speakers are rotatable in either the stored or installed positions.

11. The system as described in claim 7, wherein, in said stored position, said backing panel and said speakers are vertically aligned with said portable electronic device.

12. The system as described in claim 7, wherein said speakers and said backing panel are underneath said portable electronic device in said stored position.

13. The system as described in claim 12, wherein said speakers rotate in a plane perpendicular to said base unit plane of rotation.

14. The system as described in claim 13, further comprising locking tabs on said base unit, said tabs engaging said portable electronic device to ensure that said system remains connected to said portable electronic device.

15. A speaker system for a video amusement device, said system comprising:
two speakers, said speakers being individually rotatably mounted to a single common backing panel, and,
a base unit being rotatably mounted to said backing panel, said base unit having two electrical plug-in devices for communicating with said video amusement device, wherein said base unit has at least two pass-through ports wherein similar or identical electronic devices or auxiliary accessories can be attached, said system having an installed locking position, and a stored locking position.

16. The system described in claim 15, wherein said speakers have an extreme vertical position that is perpendicular to said backing panel, and an extreme lateral position that is axially aligned with said backing panel, said speakers being movable to any position between said extreme vertical and extreme lateral positions.

17. The system as described in claim 15, wherein said system in said stored position has a narrower profile than said system in said installed position.

18. The system as described in claim 15, wherein said portable electronic device is vertically aligned with said speakers and said backing panel when said system is in said stored position.

19. The system as described in claim 15, wherein said speakers and said backing panel are underneath said portable electronic device in said stored position.

20. The system as described in claim 15, wherein said system is changed from said installed position to said stored position by rotating said base unit in excess of one hundred eighty degrees.

21. The system described in claim 15, wherein said backing panel is parallel with said base unit when said system is in said stored position.

22. The system described in claim 15, wherein said speakers are rotatable in either the stored or installed positions.

23. The system as described in claim 15, wherein said speakers rotate in a plane perpendicular to said base unit plane of rotation.

24. The system as described in claim 15, further comprising locking tabs on said base unit, said tabs engage said portable electronic device to ensure that said system remains connected to said portable electronic device.
